(19) United States
(12) Patent Application Publication
(10) Pub. No.: US 2014/0028778 A1
(43) Pub. Date: Jan. 30, 2014

(54) SYSTEMS AND METHODS FOR AD-HOC INTEGRATION OF TABLETS AND PHONES IN VIDEO COMMUNICATION SYSTEMS

(71) Applicants: OFER SHAPIRO, Fair Lawn, NJ (US); Ran Sharon, Tenafly, NJ (US); Alexandros Eleftheriadis, Tenafly, NJ (US)

(72) Inventors: OFER SHAPIRO, Fair Lawn, NJ (US); Ran Sharon, Tenafly, NJ (US); Alexandros Eleftheriadis, Tenafly, NJ (US)

(21) Appl. No.: 13/936,904

(22) Filed: Jul. 8, 2013

Related U.S. Application Data
(60) Provisional application No. 61/668,567, filed on Jul. 6, 2012.

(51) Int. Cl. H04N 7/14

(52) U.S. Cl. CPC H04N 7/147
USPC 348/14.01

(57) ABSTRACT

The disclosed subject matter relates to video communication systems and methods that allow the ad-hoc integration of tablets and phones. In one embodiment, the system includes a first communication device equipped with a display, coupled to a communication network, and a second communication device equipped with a camera, coupled to the communication network. In the same or another embodiment, the first communication device can display a visual encoding of information that allows the second communication device to join a communication session in which the first communication device is participating, and the second communication device can scan the visual encoding of information that the first communication device is displaying and join the communication session in which the first communication device is participating.

### CROSS REFERENCE TO RELATED APPLICATION

This application claims priority to U.S. Provisional App. Ser. No. 61/668,567, titled, “Systems and Methods for Ad-Hoc Integration of Tablets and Phonesin Video Communication Systems,” filed Jul. 6, 2012, the disclosure of which is incorporated herein by reference in its entirety.

### FIELD

The disclosed subject matter relates to video communication systems that allow the ad-hoc integration of tablets and phones.

### BACKGROUND

Subject matter related to the present application can be found in the following commonly assigned patents and/or patent applications: U.S. Pat. No. 7,593,032, entitled “System and Method for a Conference Server Architecture for Low Delay and Distributed Conferencing Applications”; International Patent Application No. PCT/US06/62569, entitled “System and Method for Videoconferencing using Scalable Video Coding and Compositing Scalable Video Servers”; International Patent Application No. PCT/US06/061815, entitled “Systems and methods for error resilience and random access in video communication systems”; International Patent Application No. PCT/US07/63335, entitled “System and method for providing error resilience, random access, and rate control in scalable video communications”; International Patent Application No. PCT/US08/50640, entitled “Improved systems and methods for error resilience in video communication systems”; International Patent Application No. PCT/US11/038,003, entitled “Systems and Methods for Scalable Video Communication using Multiple Cameras and Multiple Monitors,” International Patent Application No. PCT/US12/041,695, entitled “Systems and Methods for Improved Interactive Content Sharing in Video Communication Systems”; International Patent Application No. PCT/US09/36701, entitled “System and method for improved view layout management in scalable video and audio communication systems”; International Patent Application No. PCT/US12/041,695, entitled “Systems and Methods for Improved Interactive Content Sharing in Video Communication Systems”; and International Patent Application No. PCT/US10/058,801, entitled “System and method for combining instant messaging and video communication systems.” All of the aforementioned related patents and patent applications are hereby incorporated by reference herein in their entireties.

Certain video communication applications allow the sharing of “content”. The term “content” as discussed herein can refer to or include any visual content that is not the video stream of one of the participants. Examples of content include the visual contents of a computer's screen—either the entire screen (“desktop”) or a portion thereof—or of a window where one of the computer's applications may be displaying its output.

Some systems use a “document camera” to capture such content. This camera can be positioned so that it can image a document placed on a table or special flatbed holder, and can capture an image of the document for distribution to all session participants. In modern systems, where computers are the primary business communication tool, the document camera can be replaced with a VGA input, so that any VGA video-producing device can be connected. In advanced systems, the computer can directly interface with the video communication system using an appropriate network or other connection so that it directly transmits the relevant content material to the session, without the need for conversion to VGA or other intermediate analog format.

On one end of the spectrum, content sharing may be completely passive (“passive content sharing”). In this scenario the video communication system encodes and transmits the content to the participants without providing the capability to modify it in any way. When content is driven by a computer, e.g., sharing a page of a document, it can be possible to show the cursor as well as any highlighting that is applied by the underlying software. This, however, is captured as imagery—it is not possible, in other words, for a remote participant to “take over” the cursor and perform remote editing of the document. This mode is used in many video communication applications.

On the other end of the spectrum there are distributed collaboration applications, such as shared whiteboards, and sometimes referred to as “active content sharing.” In this scenario, users are able to collaboratively edit and view a document in a synchronized fashion. The complexity in building such systems can be significant, and requires specialized protocols and applications. Oftentimes, users are not able to use their favorite applications and are forced to use special, network-aware programs (typically of lower sophistication). Thus, video communication applications typically use passive content sharing rather than active.

Certain video communication systems that rely on the Multipoint Control Unit (MCU) architecture, such as those using the ITU-T Rec. H.323 standard, “Packet-based multimedia communications systems,” incorporated herein by reference in its entirety, also can support a single content stream. ITU-T Rec. H.239, “Role management and additional media channels for H.3xx-series terminals”, incorporated herein by reference in its entirety, defines mechanisms through which two video channels can be supported in a single H.323 session or call. The first channel can be used to carry the video of the participants, and the second can be used to carry a PC graphics presentation or video. For presentations in multipoint conferencing, H.239 defines token procedures to guarantee that only one endpoint in the conference sends the additional video channel, which is then distributed to all conference participants.

When an H.323 call is connected, signaling defined in ITU-T Rec. H.245, “Control protocol for multimedia communication”, incorporated herein by reference in its entirety, can be used to establish the set of capabilities for all connected endpoints and MCUs. When the set of capabilities includes an indication that H.239 presentations are supported, a connected endpoint can choose to open an additional video channel. The endpoint must request a token from the MCU, and the MCU can check if there is another endpoint currently sending an additional video channel. The MCU can use token messages to make this endpoint stop sending the additional video channel. Then the MCU can acknowledge the token request from the first endpoint which then can begin to send the additional video channel which can contain, as an example, encoded video from a computer's video output at XGA resolution. Similar procedures can be defined for the case when two endpoints are directly connected to each other without an intermediate MCU.

Certain video communication systems used for traditional videoconferencing can involve a single camera and a single display for each of the endpoints. High-end systems, for use in dedicated conferencing rooms, can feature multiple monitors. A second monitor is often dedicated to content sharing. When no such content is used, one monitor can feature the loudest speaker whereas another monitor can show some or all of the remaining participants. When only one monitor is available, video and content must be switched, or the screen must be split between the two.

Video communication systems that run on personal computers (or tablets or other general-purpose computing devices) can have more flexibility in terms of how they display both video and content, and can also become sources of content sharing. Indeed, any portion of the computer's screen can be indicated as source for content and be encoded for transmission without any knowledge of the underlying software application (“screen dumping”, as allowed by the display device driver and operating system software). Inherent system architecture limitations, such as allowing only two streams (one video and one content) with H.300-series specifications, can prohibit otherwise viable operating scenarios (i.e., multiple video streams and multiple content streams).

So-called “telepresence” systems can convey the sense of “being in the same room” as the remote participant(s). In order to accomplish this goal, these systems can utilize multiple cameras as well as multiple displays. The displays and cameras can be positioned at carefully calculated locations in order to give a sense of eye-contact. Some systems involve three displays—left, center, and right—although configurations with only two or more than three displays are also available.

The displays can be situated in carefully selected positions in the conferencing room. Looking at each of the displays from any physical position at the conferencing room table can give the illusion that a remote participant is physically located in the room. This can be accomplished by matching the exact size of the person as displayed to the expected physical size of the subject if he or she were actually present at the perceived position in the room. Some systems go as far as matching the furniture, room colors, and lighting, to further enhance the lifelike experience.

In order to be effective, telepresence systems should offer very high resolution and operate with very low latency. For example, these systems can operate at high definition (HD) 1080p/30 resolutions, i.e., 1080 horizontal lines progressive at 30 frames per second. To eliminate latency and packet loss, the systems can use dedicated multi-megabit networks and can operate in point-to-point or switched configurations (i.e., they avoid transcoding). Some video conferencing systems assume that each endpoint is equipped with a single camera, although they can be equipped with several displays. For example, in a two-monitor system, the active speaker can be displayed in the primary monitor, with the other participants shown in the second monitor in a matrix of smaller windows. A “continuous presence” matrix layout permits participants to be continuously present on the screen rather than being switched in and out depending on who is the active speaker. In a continuous presence layout for a large number of participants, when the size of the matrix is exhausted (e.g., 9 windows for a 3×3 matrix), participants can be entered and removed from the continuous presence matrix based on a least-recently active audio policy.

A similar configuration to the continuous presence layout is the “preferred speaker” layout, where one speaker (or a small set of speakers) can be designated as the preferred speaker and can be shown in a window that is larger than the windows of other participants (e.g., double the size).

The primary monitor can show the participants as in a single-monitor system, while the second monitor displays content (e.g., a slide presentation from a computer). In this case, the primary monitor can feature a preferred speaker layout as well, i.e., the preferred speaker can be shown in a larger size window, together with a number of other participants shown in smaller size windows.

Telepresence systems that feature multiple cameras can be designed so that each camera is assigned to its own codec. For example, a system with three cameras and three screens can use three separate codecs to perform encoding and decoding at each endpoint. These codecs can make connections to three counterpart codecs on the remote site, using proprietary signaling or proprietary signaling extensions to existing protocols.

The three codecs are typically identified as “left,” “right,” and “center.” The positional references discussed herein are made from the perspective of a user of the system; left, in this context, refers to the left-hand side of a user (e.g., a remote video conference participant) who is sitting in front of a camera(s) and is using the telepresence system. Audio, e.g., stereo, can be handled through the center codec. In addition to the three video screens, the telepresence system can include additional screens to display a “content stream” or “data stream,” that is, computer-related content such as presentations.

FIG. 1 depicts the architecture of a commercially available legacy telepresence system (the Polycom TPX 306M). The system features three screens (plasma or rear screen projection) and three HD cameras. Each HD camera is paired with a codec, which is provided by an HDX traditional (single-stream) videoconferencing system. One of the codecs is labeled as “Primary.” There is a diagonal pairing of the HD cameras with the codecs so that the correct viewpoint is offered to the viewer at the remote site.

The Primary codec is responsible for audio handling. The system shown in FIG. 1 has multiple microphones, which are mixed into a single signal that is encoded by the Primary codec. There is also a fourth screen to display content. The entire system is managed by a special device labeled as the “controller.” In order to establish a connection with a remote site, the system performs three separate H.323 calls, one for each codec. This is because existing ITU-T standards do not allow the establishment of multi-camera calls. The illustrated architecture is typical of certain telepresence products that use standards-based signaling for session establishment and control. Use of the TIP protocol allows system operation with a single connection, and makes possible up to four video streams and four audio streams to be carried over two RTP sessions (one for audio and one for video).

Referring to FIG. 1, content is handled by the Primary codec (the Content Display is connected to the Primary codec). The Primary codec can use H.239 signaling to manage the content display. A legacy, non-telepresence, two-monitor system can be configured essentially in the same way as the primary codec of a telepresence system.

Telepresence systems face certain challenges that may not be found in traditional videoconferencing systems. One challenge is that telepresence systems handle multiple video streams. A typical videoconferencing system only handles a single video stream, and optionally an additional “data” stream for content. Even when multiple participants are present, the MCU is responsible for compositing the multiple participants in a single frame and transmitting the encoded frame to the receiving endpoint. Certain systems address this in different ways. For example, the telepresence system can establish as many connections as there are video cameras (e.g., for a three camera systems, three separate connections are established), and provide mechanisms to properly treat these separate streams as a unit, i.e., as coming from the same location.

The telepresence system can also use extensions to existing signaling protocols, or use new protocols, such as the Telepresence Interoperability Protocol (TIP). TIP is currently managed by the International Multimedia Telecommunications Consortium (IMTC); the specification can be obtained from IMTC at the address 2400 Camino Ramon, Suite 375, San Ramon, Calif. 94583 or from the web site http://www.imtc.org/tip. TIP allows multiple audio and video streams to be transported over a single RTP (Real-Time Protocol, RFC 3550) connection. TIP enables the multiplexing of up to four video or audio streams in the same RTP session, using proprietary RTCP (Real-Time Control Protocol, defined in RFC 3550 as part of RTP) messages. The four video streams can be used for up to three video streams and one content stream.

In both traditional as well as telepresence system configurations, content handling is thus simplistic. There are inherent limitations of the MCU architecture, in both its switching and transcoding configurations. The transcoding configuration can introduce delay due to cascaded decoding and encoding, in addition to quality loss, and is thus problematic for a high-quality experience. Switching, on the other hand, can become awkward, such as when used between systems with a different number of screens.

Scalable video coding (‘SVC’), an extension of the well-known video coding standard H.264 that is used in certain digital video applications, is a video coding technique that is effective in interactive video communication. The bitstream syntax and decoding process are formally specified in ITU-T Recommendation H.264, and particularly Annex G. ITU-T Rec. H.264, incorporated herein by reference in its entirety, can be obtained from the International telecommunications Union, Place de Nations, 1120 Geneva, Switzerland, or from the web site www.itu.int. The packetization of SVC for transport over RTP is defined in RFC 6190, “RTP payload format for Scalable Video Coding,” incorporated herein by reference in its entirety, which is available from the Internet Engineering Task Force (IETF) at the web site http://www.ietf org.

Scalable video and audio coding has been used in video and audio communication using the Scalable Video Coding Server (SVCS) architecture. The SVCS is a type of video and audio communication server and is described in commonly assigned U.S. Pat. No. 7,593,032, entitled “System and Method for a Conference Server Architecture for Low Delay and Distributed Conferencing Applications”, as well as commonly assigned International Patent Application No. PCT/US06/62569, entitled “System and Method for Videoconferencing using Scalable Video Coding and Compositing Scalable Video Servers,” both incorporated herein by reference in their entirety. It provides an architecture that allows for high quality video communication with high robustness and low delay.

Commonly assigned International Patent Application Nos. PCT/US06/061815, entitled “Systems and methods for error resilience and random access in video communication systems,” PCT/US07/63335, entitled “System and method for providing error resilience, random access, and rate control in scalable video communications,” and PCT/US08/50640, entitled “Improved systems and methods for error resilience in video communication systems,” all incorporated herein by reference in their entireties, further describe mechanisms through which a number of features such as error resilience and rate control are provided through the use of the SVCS architecture.

In one example, the SVCS can receive sealable video from a transmitting endpoint and selectively forward layers of that video to receiving participant(s). In a multipoint configuration, and contrary to an MCU, this exemplary SVCS performs no decoding/composition/re-encoding. Instead, all appropriate layers from all video streams can be sent to each receiving endpoint by the SVCS, and each receiving endpoint is itself responsible for performing the composition for final display. Therefore, in the SVCS system architecture, all endpoints can have multiple stream support, because the video from each transmitting endpoint is transmitted as a separate stream to the receiving endpoint(s). Of course, the different streams can be transmitted over the same RTP session (i.e., multiplexed), but the endpoint should be configured to receive multiple video streams, and to decode and compose them for display. This is an important advantage for SVC/SVCS-based systems in terms of the flexibility of handling multiple streams.

In systems that use the SVC/SVCS architecture, content sharing can work as follows. The user interface of the endpoint application, which can run on a personal computer, can allow the user to select any existing application window for sharing with other participants. When such a window is selected, it can appear in a list of available “shares” in the user interface of the other users. To alert them to the new share if no share is currently shown in their window, the newly introduced share can be shown in a “preferred view” (i.e., larger size view) in the main application window together with the videos of the session participants (i.e., the same way as a video participant). Since the size of this view may be small, and at any rate smaller than the size of the typical application window, the user can double-click on it so that it “pops-out” into its own window and thus allow the user to freely resize it. In a room-based system with, for example, two monitors, the content can be shown in its own monitor; if only one monitor is available. the screen can be split between video windows and the content window.

When the shared content is viewed by one or more of the participants, the originating endpoint can encode and transmit the content in the same way that it does any other source of video. The video encoding and decoding can differ in order to accommodate the particular features of computer-generated imagery, but from a system perspective, the content stream is treated as any other video stream. Note that the same video encoder can be used for content as well, but with different tuning and/or optimization settings (e.g., lower frame rate, higher spatial resolution with finer quantization, etc.). The system can support multiple content shares per endpoint, even if it may be confusing for the end user to have multiple active content shares. The inherent multi-stream support of the SVCS architecture makes content handling a natural extension of video.

Commonly assigned International Patent Application No. PCT/US11/038003, entitled “Systems and Methods for Scalable Video Communication using Multiple Cameras and Multiple Monitors,” incorporated herein by reference in its entirety, describes systems and methods for video communication using scalable video coding with multiple cameras and multiple monitors. In this case the architecture can be expanded to include multiple video displays and/or multiple sources for a particulate endpoint.

Commonly assigned International Patent Application No. PCT/US12/041,695, entitled “Systems and Methods for Improved Interactive Content Sharing in Video Communication Systems,” incorporated herein by reference in its entirety, describes improved mechanisms for handling interactive content based on the concept of “grab and draw”. This concept allows an end-user to “grab” content that is currently being shared in a session, use it in an application component that allows annotation (e.g., “draw”), and initiate his or her own share of the grabbed, annotated content. Coupled with touch-sensitive displays, which allow both intuitive “grabbing” as well as direct annotation, this mechanism can be a very effective way of visual communication.

Considering that many users today carry with them smartphones (e.g., Apple iPhone) or tablets (e.g., Apple iPad) that are equipped with a touch-sensitive display, it is desirable to design systems and methods with which such devices can be integrated into video communication systems in a seamless fashion.

### SUMMARY

Systems and methods for ad-hoc integration of tablets and phones in video communication systems are disclosed herein. In one embodiment of the present disclosure, a user can initiate the connection of a tablet or phone by triggering the display of a QR code on the communication system display. The tablet or phone scans the displayed QR code and obtains information in order to connect to the conference and participate. In one embodiment, the tablet or phone is attached to the endpoint that triggered the ad-hoc integration, whereas in another embodiment the tablet or phone is attached to one of the servers that participate in the conference. Upon connection, the tablet or phone can display shared content in full virtual resolution, and can allow the user to perform sharing of annotated content. In yet another embodiment, the displayed QR code can be used to bring the communication system into a session that has been initiated by the tablet or phone.

### BRIEF DESCRIPTION OF THE DRAWINGS

FIG. 1 illustrates the architecture of an exemplary commercial telepresence system in accordance with the prior art;

FIG. 2 illustrates the architecture of an exemplary audio and video communication system that uses scalable video (and audio) coding in accordance with one or more embodiments of the disclosed subject matter;

FIG. 3 illustrates the architecture and operation of an exemplary SVCS system in accordance with one or more embodiments of the disclosed subject matter;

FIG. 4 illustrates an exemplary spatial and temporal prediction coding structure for SVC encoding in accordance with one or more embodiments of the disclosed subject matter;

FIG. 5 illustrates an exemplary SVCS handling of spatiotemporal layers of scalable video in accordance with one or more embodiments of the disclosed subject matter;

FIGS. 6A, 6B, 6C, and 6D illustrate an exemplary user interface associated with docking, undocking, and selection of content windows, in accordance with one or more embodiments of the disclosed subject matter;

FIG. 7 illustrates an exemplary architecture of an endpoint with an interactive content sharing node unit, in accordance with one or more embodiments of the disclosed subject matter;

FIGS. 8A and 8B illustrate exemplary architectures for ad-hoc unit attachment using (a) server-based and (b) endpoint-based in accordance with two or more embodiments of the disclosed subject matter;

FIGS. 9A, 9B, 9C, 9D, and 9E illustrate an exemplary process of ad-hoc unit attachment in accordance with one or more embodiments of the disclosed subject matter; and

FIG. 10 illustrates an exemplary computer system for implementing one or more embodiments of the disclosed subject matter.

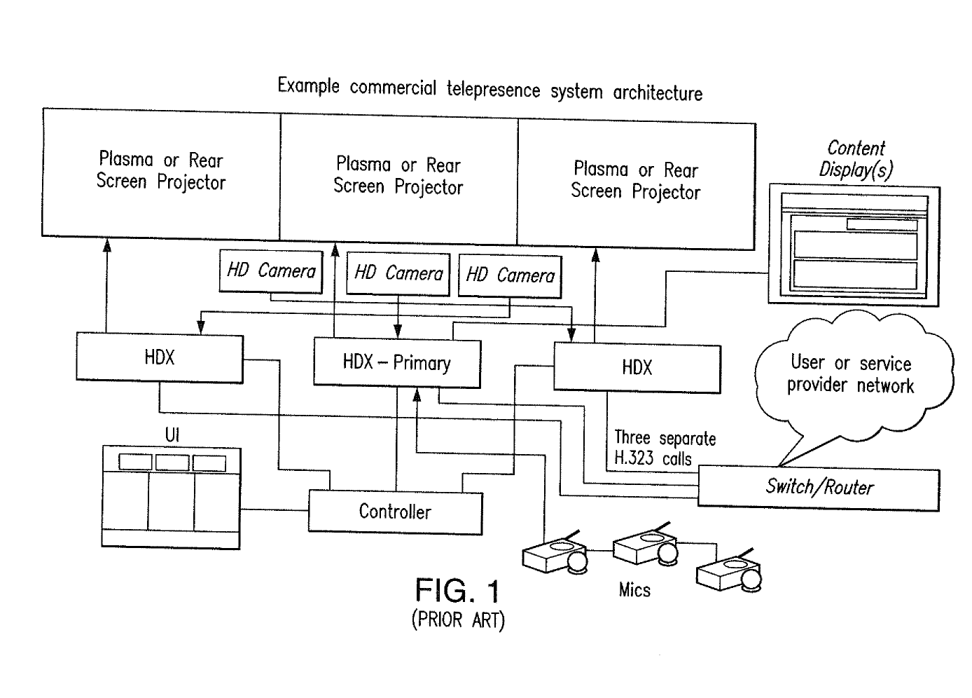

Throughout the figures the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

The present disclosure describes an audiovisual collaboration system that allows ad-hoc connection of portable devices such as smartphones and tablet computers to facilitate improved content interaction.

In one or more exemplary embodiments of the disclosed subject matter, the collaboration system can be integrated with a video communication system, which uses H.264 SVC and is based on the concept of the SVCS (see U.S. Pat. No. 7,593,032, previously cited). The same collaboration system can be used in legacy systems, including telepresence systems.

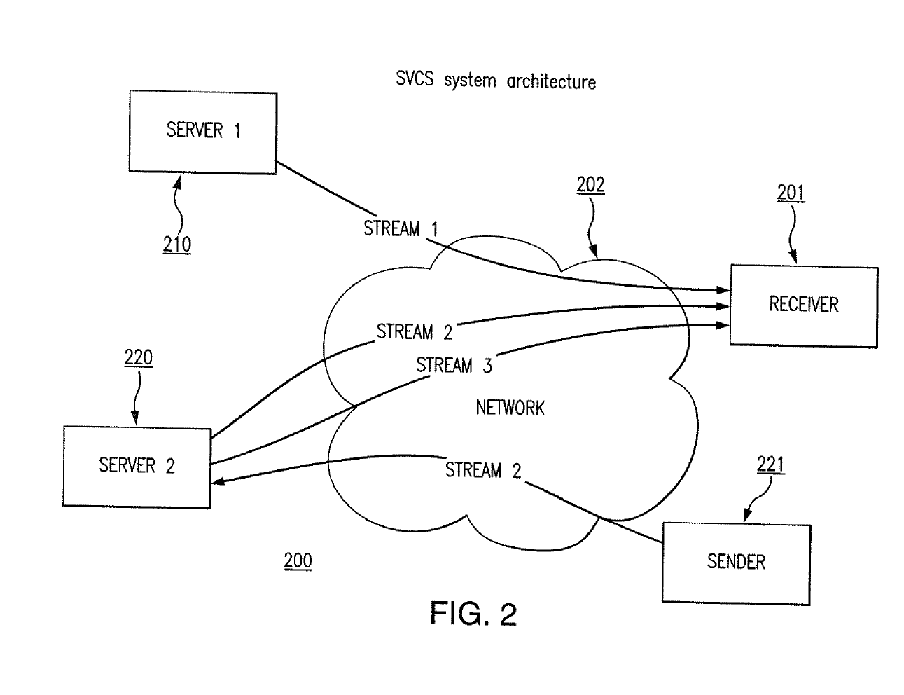

FIG. 2 depicts an exemplary system architecture 200 of an SVCS system where one or more servers can provide video and audio streams to a Receiver 201 over a Network 202 according to one or more exemplary embodiment. FIG. 2 shows two such servers, with Server 1 210 providing Stream 1, and Server 2 220 providing two streams, Stream 2 and Stream 3. Server 1 210 and Server 2 220 can be Scalable Video Communication Server (SVCS) systems and/or Scalable Audio Communication Server (SACS) systems, which can forward data received from other participants (such as Sender 221) to the receiver, or they can be stand-alone media servers (e.g., accessing content from storage). The “participants” also can be transmitting-only systems, such as units that perform encoding only (e.g., a system that encodes and transmits a live TV signal). Although the diagram shows a separate Sender and a Receiver, the present disclosure envisions that the system can perform both roles at the same time, i.e., they can both transmit and receive information.

One or more embodiments of the disclosed subject matter can use the H.264 standard for encoding the video signals and the Speex scalable codec for audio. Speex is an open-source audio compression format; a specification is available at the Speex web site at http://www.speex.org. Some of the H.264 video streams can be encoded using single-layer AVC, whereas others can be encoded using its scalable extension SVC. Similarly, some of the Speex audio streams can contain only narrowband data (8 KHz), whereas others can contain narrowband, as well as, or separately, wideband (16 KHz) or ultra-wideband (32 KHz) audio. Alternate scalable codecs can be used, including, for example, MPEG-4/Part 2 or H.263++ for video, or G.729.1 (EV) for audio. The Network 202 can be any packet-based network; e.g., an IP-based network, such as the Internet.

In one or more embodiments of the disclosed subject matter, the Receiver 201 and Sender 221 is a general-purpose computer such as PC or Apple computer, desktop, laptop, tablet, etc. running a software application. They can also be dedicated computers engineered to only run the single software application, for example, using embedded versions of commercial operating systems, or even standalone devices engineered to perform the functions of the receiving and sending application, respectively. The receiving software application can be responsible for communicating with the server(s), for establishing connections and/or for receiving, decoding, displaying or playing back received video, content, and/or audio streams. The sending application, or the same receiving application for systems that are both senders and receiver, can also transmit back to a server its own encoded video, content, and/or audio stream.

Transmitted streams can be the result of real-time encoding of the output of one or more cameras and/or microphones attached to Sender 221, or they can be pre-coded video and/or audio stored locally on the Sender 221 or on a data source either accessible from the Sender 221 over the Network 202, or directly attached to it. For content streams, the source material can be obtained directly from a computer screen, through an intermediate analog or digital format (e.g., VGA), or it can be produced by a camera (e.g., a document camera). Other means of obtaining visual content are also possible as persons skilled in the art will recognize.

In one or embodiments, the Sender 221 can be equipped with a connected camera and/or microphone, and can encode and transmit the produced video and audio signal to other participants via a Server 2 220 over a Stream 2. The Sender 221 can also produce one or more content streams that are similarly transmitted to the Server 220 over the same Stream 2. Although FIG. 2 illustrates one server in the path from a Sender to a Receiver, more than one server can exist in the path. Also, although all types of content can be transmitted over a single stream (multiplexed), each type of content can be transmitted over its own stream or, indeed, a network (e.g., wired and wireless networks).

In accordance with the SVCS architecture, a Receiver can compose the decoded video streams (as well as any content streams) received from the Server(s) on its display, and can mix and play back the decoded audio streams. Traditional multi-point video servers such as transcoding MCUs can perform this function on the server itself, either once for all receiving participants, or separately for each receiving participant.

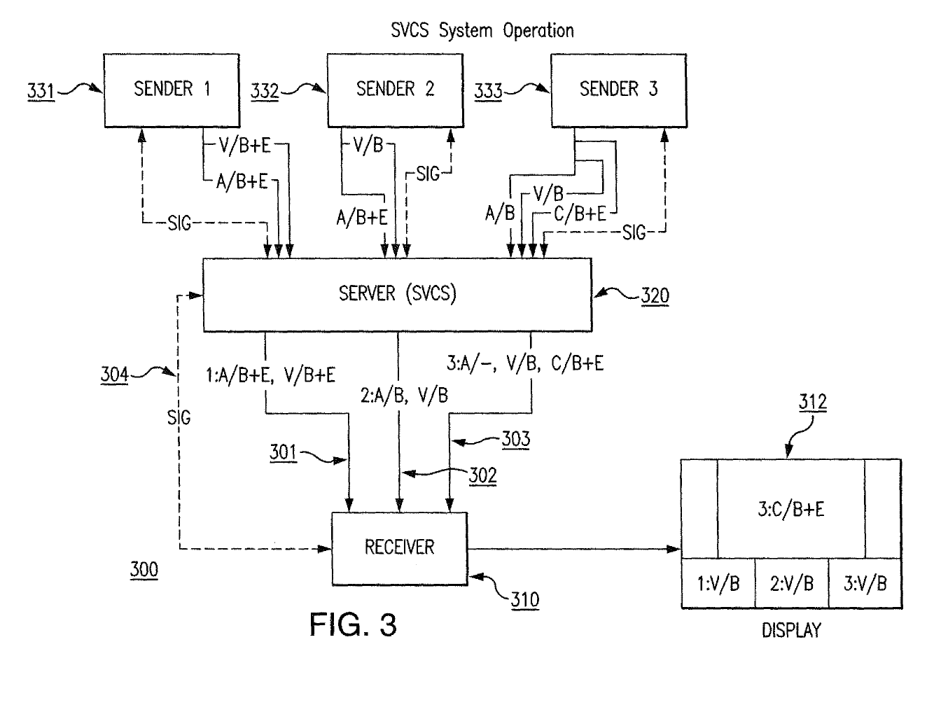

The operation of the Servers 210 and 220 is further detailed in FIG. 3. FIG. 3 depicts an exemplary system 300 that includes three transmitting participants, Sender 1 331, Sender 2 332, and Sender 3 333, a Server (SVCS) 320, and a Receiver 310. The particular configuration is just an example; a Receiver can perform the operations of a Sender, and vice versa. Furthermore, there can be more or fewer Senders, Receivers, or Servers.

In one or more embodiments of the disclosed subject matter, scalable coding can be used for the video, content, and audio signals. The video and content signals can be coded, e.g., using H.264 SVC with three layers of temporal scalability and two layers of spatial scalability, with a ratio of 2 between the horizontal and/or vertical picture dimensions between the base and enhancement layers (e.g., VGA and QVGA).

Each of the senders, Sender 1 331, Sender 2 332, and Sender 3 333 can be connected to the Server 320, through which the sender can transmit one or more media streams—audio, video and/or content. Each of the senders, Sender 1 331, Sender 2 332, and Sender 3 333 also can have a signaling connection with Server 320 (labeled ‘SIG’). The streams in each connection are labeled according to: 1) the type of signal, i.e., A for audio, V for video, and C for content; and 2) the layers present in each stream, B for base and E for enhancement. In this particular example depicted in FIG. 3, the streams transmitted from Sender 1 331 to Server 320 includes an audio stream with both base and enhancement layers (“A/B+E”) and a video stream with again both base and enhancement layers (“V/B+E”). For Sender 3 333, the streams include audio and video with base layer only (“A/B” and “V/B”), as well as a stream with content with both base and enhancement layers (“C/B+E”).

The Server 320 can be connected to the Receiver 310; packets of the different layers from the different streams can be received by the Server 320, and can be selectively forwarded to the Receiver 310. Although there may be a single connection between the Server 320 and the Receiver 310, those skilled in the art will recognize that different streams can be transmitted over different connections (including different types of networks). In addition, there need not be a direct connection between such elements (i.e., one or more intervening elements can be present).

FIG. 3 shows three different sets of streams (301, 302, 303) transmitted from Server 320 to Receiver 310. In an exemplary embodiment, each set can correspond to the subset of layers and/or media that the Server 320 forwards to Receiver 310 from a corresponding Sender, and is labeled with the number of each sender. For example, the set 301 can contain layers from Sender 1 331, and is labeled with the number 1. The label also includes the particular layers that are present and/or a dash for content that is not present at all. In the present example, the set of streams 301 is labeled as “1:A/B+E, V/B+E” to indicate that these are streams from Sender 1 331, and that both base and enhancement layers are included for both video and audio. Similarly, the set 303 is labeled “3:A/−, V/B, C/B+E” to indicate that this is content from Sender 3 333, and that there is no audio, only base layer for video, and both base and enhancement layer for content.

With continued reference to FIG. 3, each of the senders, Sender 1 331, Sender 2 332, and Sender 3 333, can transmit zero or more media (video, audio, content) to the Server 320 using a combination of base or base plus enhancement layers. The particular choice of layers and/or media can depend on several factors. For example, if a Sender is not an active speaker, no audio can be transmitted by that Sender. Similarly, if a participant is shown at low resolution, no spatial enhancement layer can be transmitted from that particular participant. Network bitrate availability can also dictate particular layer and/or media combination choices. These and/or other criteria also can be used by the Server 320 in order to decide which packets (corresponding to layers of particular media) to selectively forward to Receiver 320. These criteria can be communicated between Receiver 310 and the Server 320, or between the Server 320 and one of the senders Sender 1 331, Sender 2 332, and Sender 3 333, through appropriate signaling channels (labeled as “SIG,” e.g., 304).

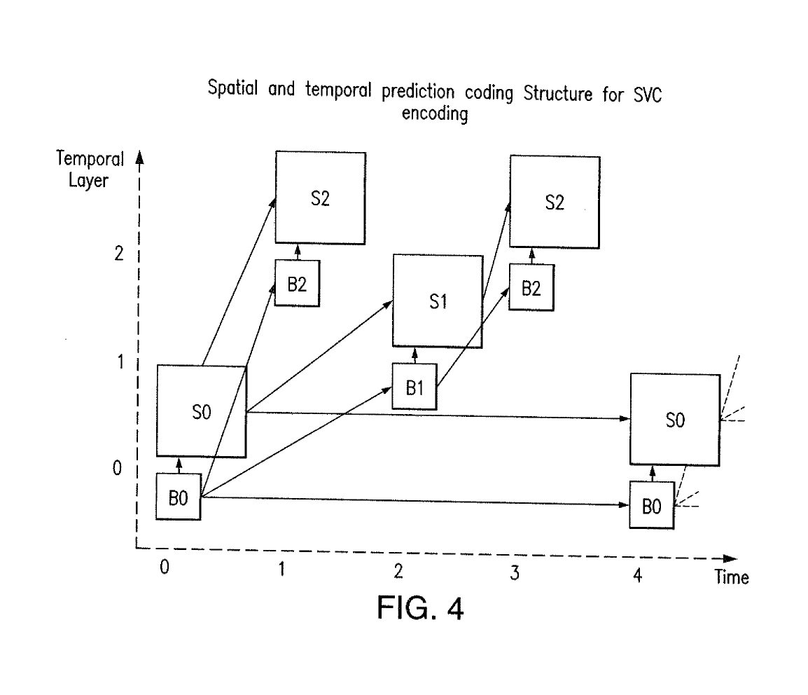

The spatiotemporal picture prediction structure in one or more embodiments of the disclosed subject matter is shown in FIG. 4. The elements labeled with the letter “B” designate a base layer picture whereas the elements labeled with the letter “S” designates a spatial enhancement layer picture. The number following the letter “B” or “S” in each label indicates the temporal layer, 0 through 2. Other scalability structures can also be used, including, for example, extreme cases such as simulcasting (where no interlayer prediction is used). Similarly, the audio signal can be coded with two layers of scalability, narrowband (base) and wideband (enhancement). Although scalable coding is assumed in some embodiments, the disclosed subject matter can be used in any videoconferencing system, including legacy systems that use single-layer coding.

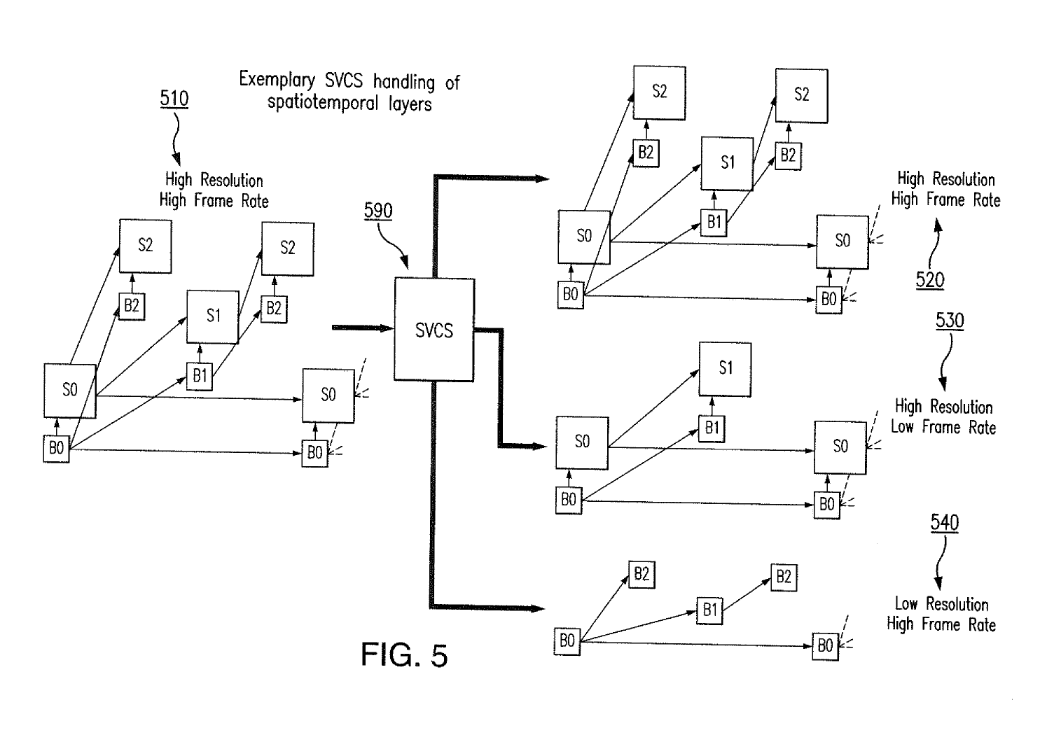

FIG. 5 illustrates an exemplary handling by an SVCS of different layers present in the spatiotemporal picture prediction structure of FIG. 4. FIG. 5 shows a scalable video stream that has the spatiotemporal picture prediction structure 510 of FIG. 4 being transmitted to an SVCS 590. The SVCS 590 can be connected to three different endpoints (not shown in FIG. 5). The three endpoints can have different requirements in terms of the picture resolution and/or frame rates that each endpoint can handle, and can be differentiated in a high resolution/high frame rate 520, high resolution/low frame rate 530, and low resolution/high frame rate 540 configuration. For the high resolution/high frame rate endpoint, the system can transmit all layers; the structure can be identical to the one provided at the input of the SVC 590. For the high resolution/low frame rate configuration 530, the SVCS 590 can remove the temporal layer 2 pictures (B2 and S2). Finally, for the low resolution/high frame rate configuration 540, the SVCS 590 can remove all the “S” layers (i.e., S0, S1, and S2). FIG. 5 is one example, and different configurations and different selection criteria are possible.

As discussed above, the SVCS system architecture is inherently multi-stream, since each system component must be able to handle multiple streams of each type. Significantly, the actual composition of video and/or mixing of audio typically occurs at the receivers. Returning to FIG. 3, the composition of video and/or content can occur at the Receiver 310. FIG. 3 depicts a single Display 312 attached to the Receiver 310. In this particular example, the system can compose the incoming video and content streams using a “preferred view” layout, in which the content stream from Sender 3 333 can be shown in a larger window (labeled “3:C/B+E” to indicate that it is content from Sender 3 and includes both base and enhancement layers), whereas the video streams from all three senders (1, 2, and 3) can shown in smaller windows (labeled “1:V/B”, “2:V/B”, “3:V/B”, indicating that only the base layer is used).

The layout depicted in FIG. 3 is one example of a SVCS system layout. In another example, in a two-monitor system, the Receiver 310 can display the content stream in one of its two monitors on its own, and the video windows can be shown in the other monitor. Commonly assigned International Patent Application No. PCT/US09/36701, entitled “System and method for improved view layout management in scalable video and audio communication systems,” incorporated herein by reference in its entirety, describes additional systems and methods for layout management. Previously cited International Patent Application No. PCT/US11/038,003, “Systems and Methods for Scalable Video Communication using Multiple Cameras and Multiple Monitors,” describes additional layout management techniques specifically addressing multi-monitor, multi-camera systems.

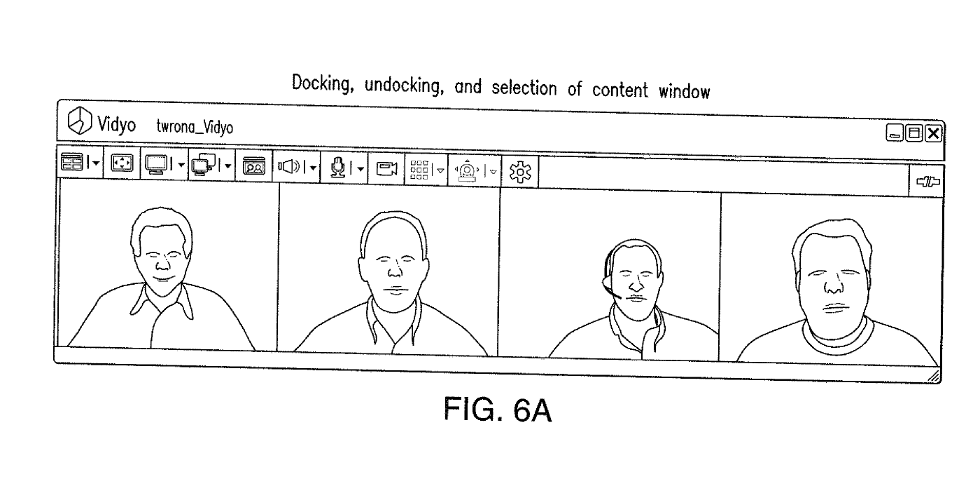

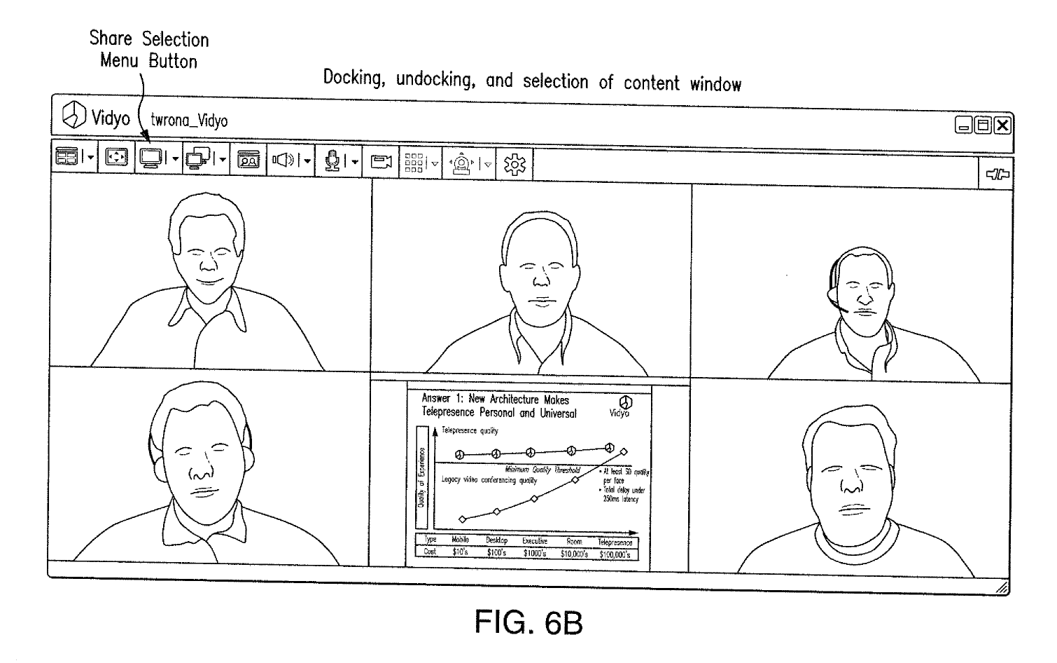

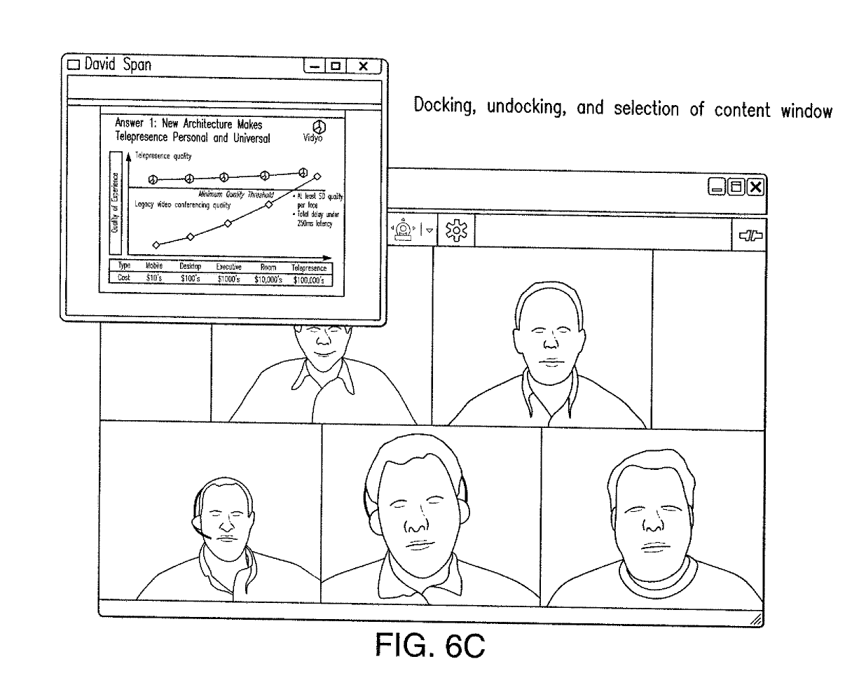

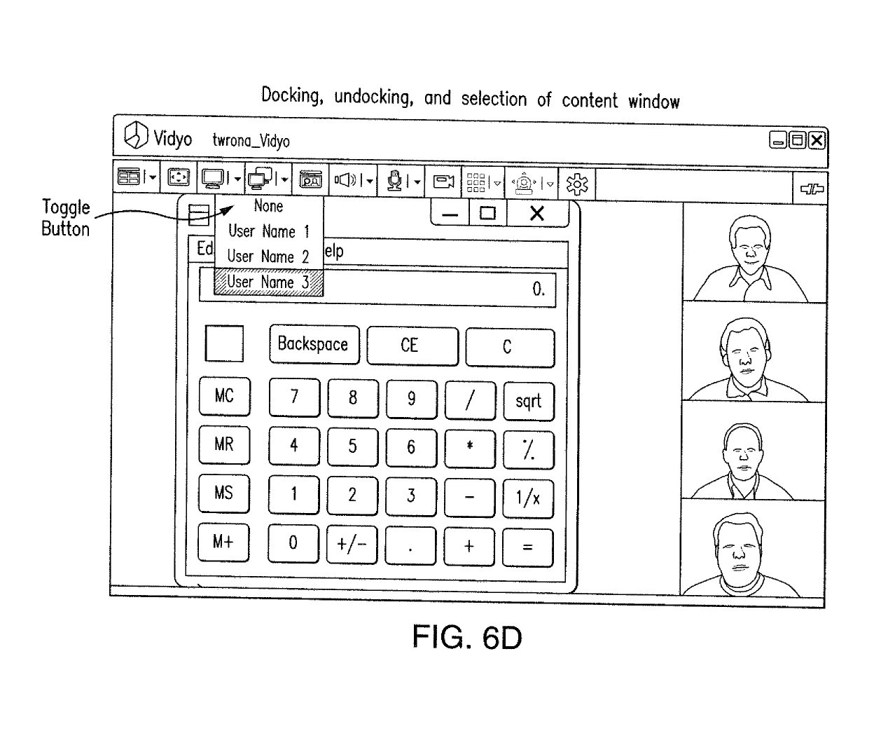

FIGS. 6A, 6B, 6C, and 6D illustrate the process of content sharing in one or more embodiments of the disclosed subject matter, where the exemplary system can perform content sharing by allowing endpoint software that runs on personal computers to share one or more of the application windows. FIG. 6A illustrates an exemplary user interface of a software implementing an endpoint for a user that is part of a videoconference with four participants; four video windows, one for each participant, are shown. A participant can press the “Share” selection button depicted in FIG. 6B to initiate sharing of an application window, i.e., the window of an application that is currently running on that participant's computer. The button can act as a drop-down menu (not shown in FIG. 6B), and can list all the currently available windows as reported by the operating system of the host computer. When a window is selected for sharing, the sharing can be activated and the button can indicate that sharing is active, e.g., the color of the button can turn from gray to green.

When the share is activated, all participants can start receiving an additional content window displaying the shared content. FIG. 6B illustrates an exemplary user interface for a user that is part of a videoconference with five participants, one of whom has shared an application window. FIG. 6B depicts a user interface that can display five windows showing each of the five participants, and a sixth window in the lower center position of the user interface that can display an application window. From a system-level point of view, the transmission of this content through the system can be no different than audio or video, but the details of its resolution, frame rate, as well as encoding and decoding processes, can be different. The content window may be too small to view characters and other small size features. The exemplary interface can allow the user to double-click the content window so that it “pops-out” into its own separate window as shown in FIG. 6C. Here the content view is in its own window, and which the user can resize, whereas the main videoconferencing application window can show the video views of the participants.

Since users can simultaneously share application windows, and a user can share more than one window, a mechanism can be provided to select which share a user views. This can be performed in an exemplary system via the “Toggle” button, as shown in FIG. 6D. When pressed, the Toggle button can display a drop-down menu with a list of available shares, and can include the name of the user who is making the share available. One entry in the drop-down menu can allow the user to choose to show no share window.

In one or more embodiments of the disclosed subject matter, the video communication system can feature an interactive content sharing unit, as described in commonly assigned International Patent Application No. PCT/US12/041,695, entitled “Systems and Methods for Improved Interactive Content Sharing in Video Communication Systems,” previously cited. More specifically, in one or more embodiments of the disclosed subject matter, the system can use a touch-screen All-In-One (AIO) personal computer that can run a content sharing only videoconferencing client (e.g., the system does not have a camera and/or microphone connected). The touch screen display can act as a whiteboard. During normal operation, it can show the data share of the conference; As explained above, this can be accomplished by encoding at the originating participant a window of the computer's screen, and distributing to all other participants as with regular video streams. In the same or another embodiment of the disclosed subject matter, the content sharing window can originate from an H.239 client, or any other visual communication protocol. The image shown on the touch screen can also be a regular video stream showing one or more of the participants.

The touch screen can allow a user to touch the screen, thus “grabbing” the image. When doing so, the system can take a snapshot of the content currently displayed on the share window, and create a new share. In one embodiment of the present disclosure, the new share can be shown in a window that features a whiteboard application, through which the user can annotate the snapshot image. In one or more embodiments of the present disclosure, whiteboard annotations can include, for example, selecting different colors from a palette, drawing on the snapshot, or clearing all annotation.

The snapshot image with which the whiteboard interaction starts can be the image previously shared by the other party. The whiteboard image, including any annotations, can be shared with other session participants as any other window share.

In one or more embodiments of the disclosed subject matter, a user can be equipped with a portable device such as, for example, a smartphone or tablet; the device will be referred to herein as an Ad-Hoc Unit (AHU). In one or more embodiments of the present invention, the AHU can be equipped with a touch screen and a camera.

In order to allow the AHU to connect to an on-going communication session, AHU architecture can be an endpoint-based embodiment or a server-based embodiment. In the endpoint-based embodiment, the AHU is attached to the endpoint, whereas in the server-based embodiment, the AHU connects to the server. Both embodiments are described in detail in the following.

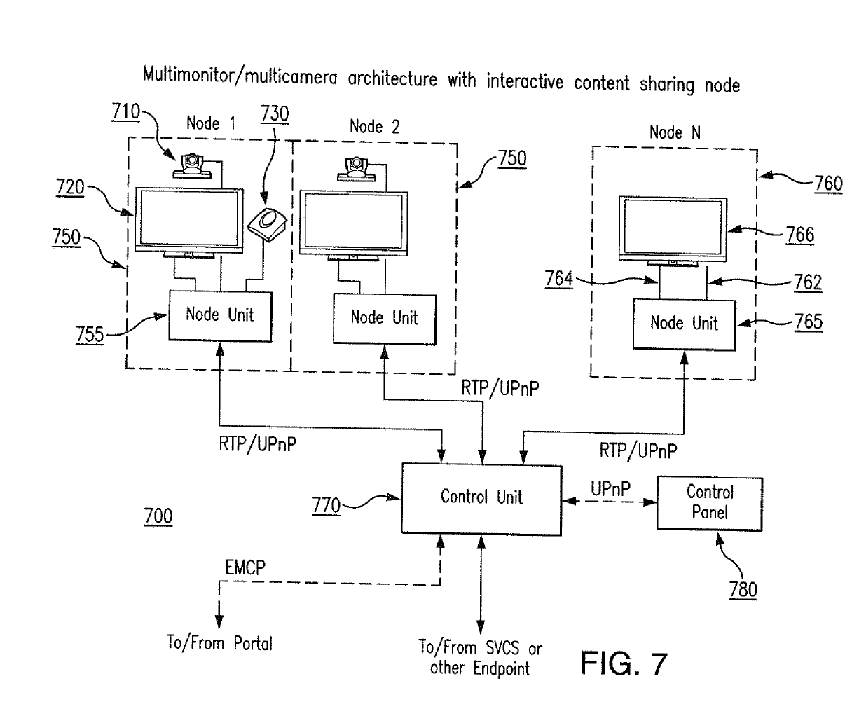

FIG. 7 illustrates one or more endpoint-based embodiments of the disclosed subject matter, where the endpoint architecture is based on the multicamera/multimonitor system design described in previously cited and commonly assigned International Patent Application No. PCT/US11/038,003. FIG. 7 shows an Endpoint 700 that can be comprised of a Control Unit 770 and a set of Nodes 750 and 760. An endpoint can include any number of Nodes; in FIG. 7, N Nodes are shown. The N-th node can be a special type of node called “Content Sharing Node”. A single such Node is shown for purposes of illustration; any number of nodes can be Content Sharing Nodes. Each Node 750 can consist of a Node Unit 755, which can be connected to a monitor 720, a camera 710 and/or an audio device 730, referred to herein as a peripheral device (e.g., a microphone, speaker, or combination of the two, in either mono or stereo). The Node Units 750 and 760 can be connected to the Control Unit 770, which can be the operational control center of the endpoint 700. The Control Unit can communicate with SVCS and management servers such as a Portal. The endpoint 700 can also have a Control Panel 780 that can communicate with the Control Unit 770 and can allow the operator to make system selections and/or change system settings. The Control Panel 780 can be, for example, an application running on an Apple iPad device.

Node 760 is a special node in that it includes a touch screen 766 instead of a regular monitor 720. The touch screen 766 can be connected to its Node Unit 765 via a video connection 764, but it also can have a second connection 762 that can provide information about the touch screen status. The second connection 762 can be, for example, a USB or Bluetooth connection, or any other suitable connection. It is also possible that the two connections are over the same physical connection (e.g., over a Thunderbolt connection). In one or more embodiments of the disclosed subject matter, the Content Sharing Node unit can have a regular monitor (e.g., monitor 720) and can be equipped with a pointing device such as a mouse (not shown in FIG. 7). Alternative mechanisms for obtaining user interaction are also possible, as is apparent to persons skilled in the art.

The endpoint 700 can participate in a video communication session like a regular endpoint, as described in International Patent Application No. PCT/US11/038,003 (previously cited). Further, as explained in International Patent Application No. PCT/US12/041,695 (previously cited), the touch screen 766 can allow the user to touch a point on the screen (e.g., a “grab” button) and can instruct the system to “grab” a snapshot of the image currently shown on the screen. The Node 760 can allow the user to annotate the grabbed content (e.g., “draw”), which at the same time can be shared with all other participants as any other type of shared content. This process is referred to as “grab and draw”.

Although FIG. 7 shows the grab and draw process in the context of the Content Sharing Node, which can be part of a bigger multimonitor/multicamera system, the same process can be performed by a dedicated endpoint that can include either just the grab and draw features (i.e., lacking a camera and/or microphone), or an endpoint that can integrate the camera and/or microphone with the grab and draw functionality. One example is an All-in-One personal computer with a touch-sensitive display.

An AHU has all the characteristics of a Content Sharing Node or an endpoint that implements the grab and draw functionality. AHUs generally feature general-purpose computational processing capabilities, coupled with a touch-sensitive display and typically a camera. Most commercial videoconferencing systems today, in fact, feature support for popular smartphone architectures and tablets. An AHU, however, may not be configured to be a permanent component of a collaboration system. It may thus be necessary to have a mechanism through which the AHU can become a temporary component of the collaboration system so that it can be used in an on-going session. Before describing exemplary mechanisms for such ad-hoc integration, we first describe the two different embodiment architectures.

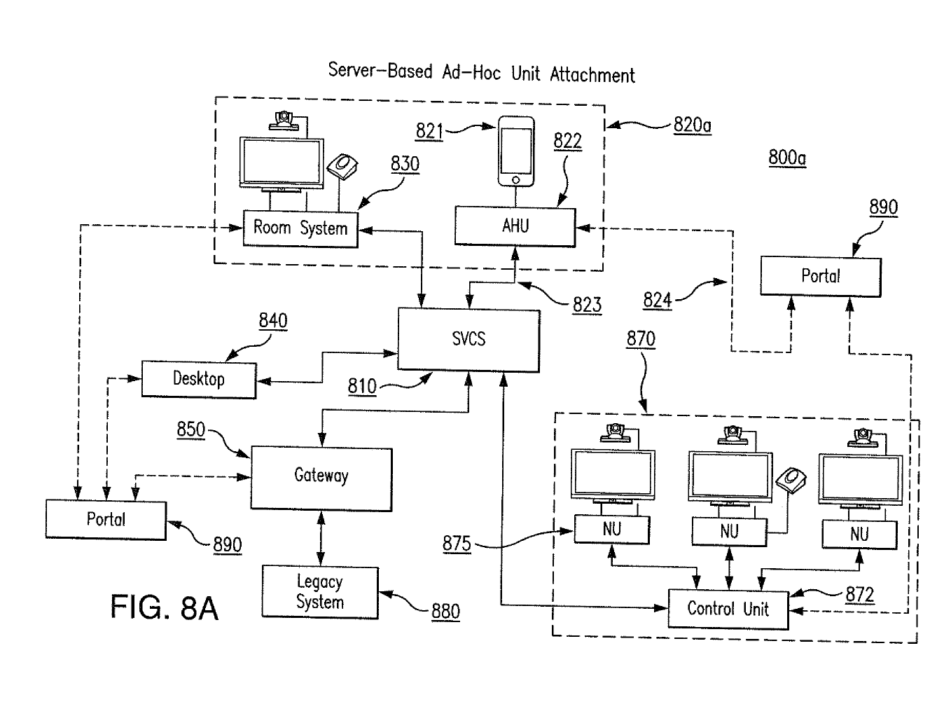

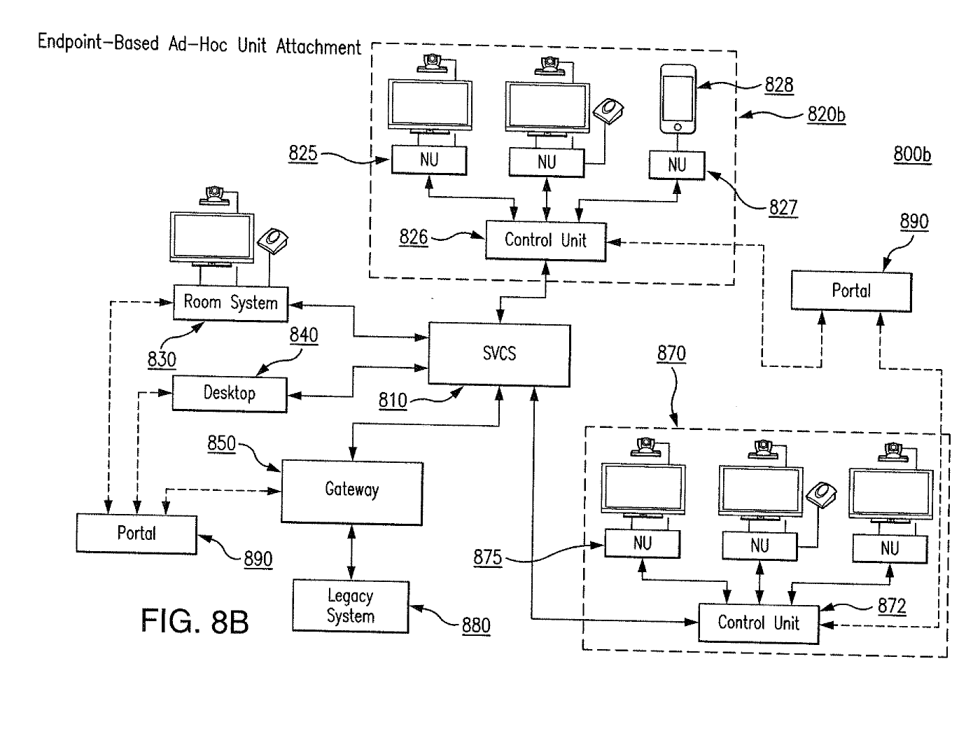

FIG. 8A depicts the server-based AHU attachment architecture 800a, where a user is at a Room System 830 and carries an AHU 821 that can be equipped with appropriate AHU software 822. Using the ad-hoc connection process described below, the AHU 821 attaches to the Portal 890 and SVCS 810 like any other endpoint. The figure shows a variety of other types of endpoints: a Desktop 840, a Telepresence system 870 that can have multiple cameras and/or multiple monitors, as well as a Gateway 850 that can connect to a Legacy System 880 (e.g., an H.323 terminal or MCU). The AHU 821 and Room System 830 can be associated together as an extended Endpoint 820a. This association is purely logical and entirely optional. The particular selection of endpoints and/or gateways is only used for purposes of illustration; any number of endpoints can be used, as well as any number of legacy endpoints or gateways, as is apparent to persons skilled in the art.

FIG. 8B depicts the endpoint-based AHU attachment architecture 800b, where Endpoint 820b can be of the multimonitor/multicamera type, and the AHU 828 can be attached using the ad-hoc connection process described below through special Node Unit software 827 that runs on the AHU. From the point of view of the Control Unit 826, the AHU 828 can be just another Interactive Content Sharing Node, similar to the one shown in FIG. 7 (Node 760). As in FIG. 8A, the figure shows a variety of other types of endpoints: a Desktop 840, a Telepresence system 870 that can have multiple cameras and/or multiple monitors, as well as a Gateway 850 that can connect to a Legacy System 880 (e.g., an H.323 terminal or MCU). All these units can be identical between the two different architectures, and are thus shown in FIGS. 8A and 8B with the same identifying numbers. The particular selection of endpoints and/or gateways is only used for purposes of illustration; any number of endpoints can be used, as well as any number of legacy endpoints or gateways, as is apparent to persons skilled in the art.

We now examine the process for the ad-hoc attachment of the AHU to a system, in accordance with the principles of the disclosed subject matter. A key objective is that no prior configuration should be necessary, with the exception of, for example, installing the appropriate client software on the AHU. A second key objective is that the process should require no modification to the operating procedures of existing systems.

The process of ad-hoc attachment in one or more embodiments of the present invention is initiated by the end user on the main system, e.g., Endpoint 820a or Endpoint 820b. The end user can, for example, press a button on the user interface (e.g., labeled “Add Phone/Tablet”). Upon initiation, in one embodiment of the disclosed subject matter, the system can display a QR (Quick Response) Code on one of its display monitors. QR Codes are two-dimensional bar codes and are described in U.S. Pat. No. 5,726,435, “Optically readable two-dimensional code and method and apparatus using the same”, as well as International Standard ISO/IEC 18004:2000, “Information Technology: Automatic identification and data capture techniques. Bar code symbology. QR Code.” QR codes can store fairly large amounts of data in different formats. The actual capacity can depend on the data type (mode, or input character set), version (1 through 40, indicating the overall dimensions of the symbol) and/or error correction level. For example, for 40-L symbols (version 40, error correction level L) a QR Code can store 7,089 characters of numeric only data or 4,296 alphanumeric (including punctuation) characters, whereas for binary data the QR Code can store 2,953 bytes. Such capacity can be used to encode in a single QR code information about how to connect to an on-going communication session, appropriate authentication credentials such as a login and password and/or other pertinent information.

Although QR codes are used in all examples indicated in the present disclosure, other types of visually identifiable codes are also possible, such as traditional one-dimensional bar codes, as well as other 2-dimensional codes including High Capacity Color Barcodes (developed by Microsoft), MaciCode (used by United Parcel Service), PDF417 (developed by Symbol Technologies), etc. It is also possible that multiple such codes are displayed at the same time, providing duplicate or complementary information.

In one or more embodiments of the disclosed subject matter, a QR Version 10 (57×57) code is used, capable of encoding up to 174 characters. In one or more embodiments of the disclosed subject matter, the encoded data can be in the form of a URL coupled with appropriate arguments. The URL can point to a server from which the AHU can download the client software to participate in the type of conference session that is being run, whereas the arguments to the URL can be information with which the downloaded software will be configured, and which will allow it to connect to the conference. One example of an encoded string is: “http://www.abc.com/ahu.php?e=192.168.1.5&s=HQ&u=guest&p=test”. In this example, the URL can instruct the AHU to connect to the server www.abc.com using the standard HTTP protocol, and execute the script “ahu.php” with the arguments “e=192.168.1.5” to indicate the IP address of the endpoint, “s=HQ” to indicate the name of the conference session to join, and “u=guest” with “p=test” to provide a corresponding user name and password. The “ahu.php” script can package these parameters together with the executable program that can then feed back to the AHU.

In another embodiment of the disclosed subject matter the QR coded string can be read directly by pre-loaded conferencing software that can exist on the AHU. The QR coded string would then only need to provide information about the system to connect to and/or other session parameters. Use of URLs to connect to conference sessions is described in commonly assigned International Patent Application No. PCT/US10/058,801, entitled “System and method for combining instant messaging and video communication systems,” incorporated herein by reference in its entirety.

Depending on the attachment architecture used, i.e., endpoint-based or server-based, the QR coded data may need to provide information on the network address of the device to attach to, as well as session naming information and/or login credentials. A time window can be encoded into the URL during which the URL can be considered valid. This can ensure that a code can only be used over a set period of time. In one or more embodiments of the disclosed subject matter, the conferencing system can generate pre-authorization tokens that can be embedded in the URL, which can also have a specific period of validity. This allows the system to unilaterally revoke the validity of a given URL.

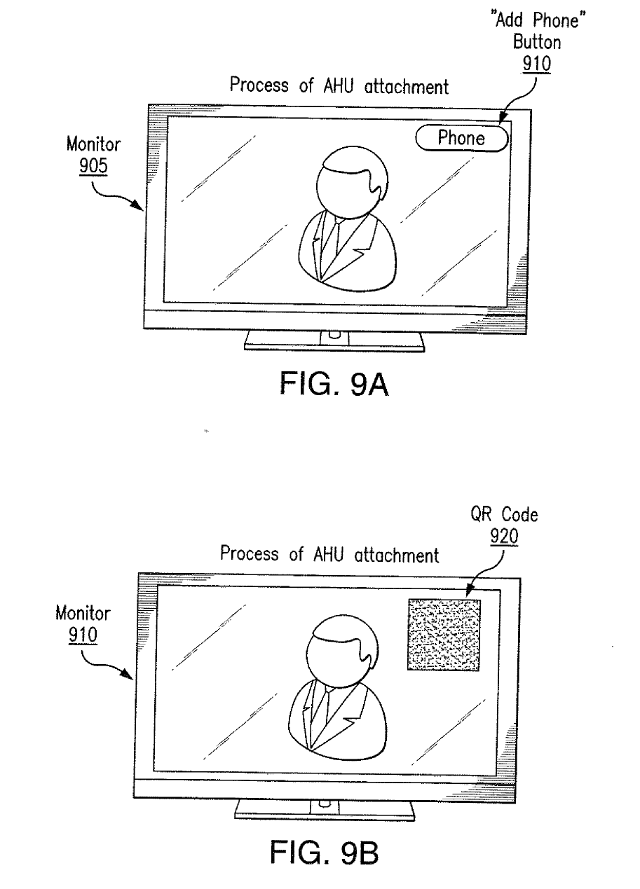

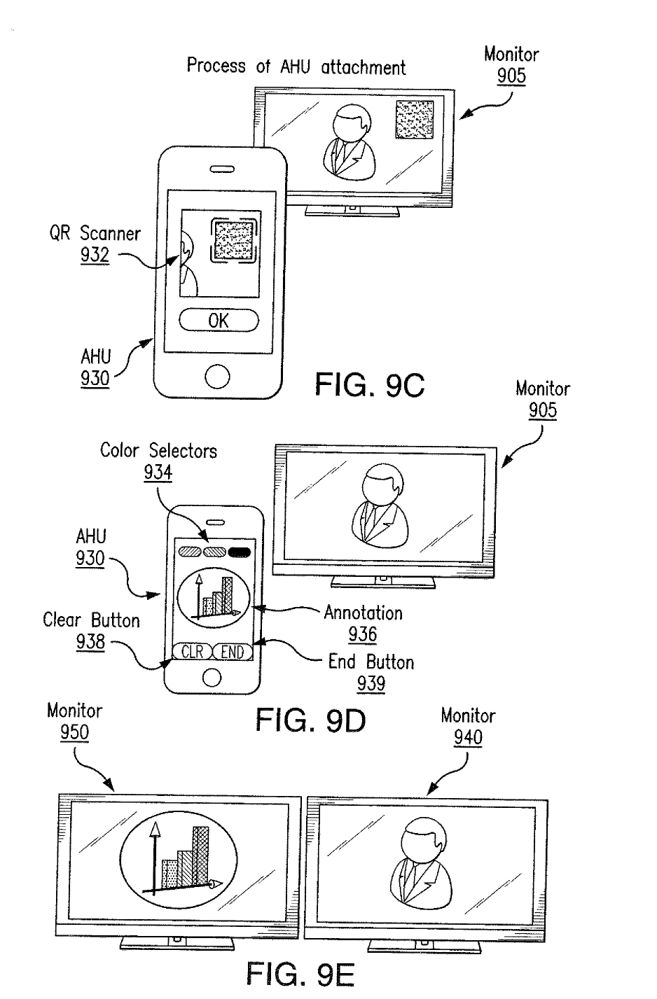

FIGS. 9A, 9B, 9C, 9D, and 9E depict the process of AHU attachment in accordance with the disclosed subject matter. Regardless of the specific information encoded in the QR code, and whether or not a server-based or endpoint-based attachment process is used, when the user selects to integrate an AHU in a session (e.g., by clicking a button on the user interface, remote control, or other interface means), the relevant QR code can be shown on the screen. The user can point his or her AHU to the display and use a QR Reader application, or pre-loaded AHU software, to scan the displayed QR code. After the code is scanned, the code can be executed and the AHU can become attached to the conferencing session and become a content-sharing endpoint.

The software of the AHU in one or more embodiments of the present disclosure allows the AHU to display shared content using the full resolution, by allowing the user to pan the image in the typically small AHU screen. A user can view high resolution imagery on a relatively small-sized screen. Some phones and tablets allow easy zooming in and out using multi-touch gestures (e.g., pinching, etc.). In one or more embodiments of the disclosed subject matter, the AHU software also can allow images that are locally stored on the AHU to become sources of shared content in the conferencing session. In one or more embodiments of the present disclosure, the AHU can offer full capability for annotating the content, thus enabling full support for features such as grab and draw at the AHU.

The steps of an exemplary process of attaching an AHU to a conferencing session in accordance with the principles of the disclosed subject matter is shown in FIGS. 9A, 9B, 9C, 9D, and 9E. In step FIG. 9A, conferencing Monitor 905 shows a remote participant as well as an “Add Phone” Button 910. When the Add Phone Button 910 is pressed, in step FIG. 9B, the conferencing system can display the QR Code 920. The displayed QR Code can be scanned by the AHU 930 through its built-in camera, using appropriate QR Scanner software 932, in step FIG. 9C. The scanned code can be used to enter the session and retrieve shared content in FIG. 9D. The AHU 930 can use content annotation software which, for example, can offer Color Selectors 934 to create Annotation 936. The content annotation software can also feature a Clear Button 938 to reset the annotations and/or an End Button 939 to terminate the participation of the AHU in the session. Remote sites, such as the dual monitor site shown in FIG. 9E, can depict the content shared by the AHU 930 like any other shared content. The user interface components of the annotation software that runson the AHU 930 are not shown in the remote sites; only the associated content and the annotations themselves.

If the AHU is not equipped with a camera, the conferencing system can display a shortened URL on the screen, using the services of, for example, bit.ly. The end-user can manually type the URL string on the AHU. In both this, as well as the QR Code technique, the user that owns the AHU does not need to have an account on the conferencing system.

In another embodiment where the system is assumed to know the user's URL, e.g., because he or she is assumed to be logged into the system on the main conferencing system, the conferencing system can email the user the URL. The user can access the email message on the AHU and click on the emailed URL. If a different user owns the AHU, the logged in user can easily forward the URL to the email address of the actual AHU owner.

In the preceding description it has been assumed that the conference session is set up by a conferencing system endpoint, and that the AHU is brought into the conference as an ancillary device. The exact same mechanisms, however, can be used in the reverse direction: bringing a conferencing system endpoint into a session that has been initiated by the AHU. The growing use of phones and tablets as stand-alone conferencing system endpoints makes them likely candidates for initiating sessions by individual users. Contrary to room-based endpoints, these portable devices are usually owned and configured by the users themselves, and are thus more convenient for initiating conferencing sessions.

In embodiments where the AHU is the main conferencing device, and where the conferencing system endpoint is brought into an existing conference, the server-based AHU attachment architecture of FIG. 8A is assumed to be used. This architecture allows the AHU to have an independent connection to the conferencing system server (the SVCS 810), separate from the connection of (or existence of) a conferencing endpoint such as Room System 830.

In order to bring a conferencing system endpoint such as Room System 830 into a conferencing session in which an AHU 821/822 is participating, nearly the same steps shown in FIGS. 9A, 9B, 9C, 9D, and 9E can be used. The process starts with the user pressing, for example, a button on the user interface of the endpoint (e.g., labeled “Add Room System to Conference”). Upon initiation, in one embodiment of the disclosed subject matter, the system can display a QR code on one of its display monitors that provides information for identifying and inviting the particular endpoint to a conference. The QR code is scanned by a camera on the AHU, which then uses the scanned information to instruct the conferencing server to invite the particular endpoint to the conference. The server invites the endpoint to the conference, and the endpoint automatically accepts the invitation without requiring further user input. In some embodiments of the disclosed subject matter it is possible that the endpoint will ask for further confirmation from the user of the endpoint before joining the conference. In some embodiments of the disclosed subject matter the endpoint will accept invitations for a certain period of time after the process is initiated by the end user. This time may be arbitrary; in some embodiments of the disclosed subject matter it may be 3 minutes. Note that the process does not depend on if the original conference session was initiated by the AHU or some other participant.

While the ad-hoc integration process is described herein in the context of videoconferencing systems, it is obvious to persons skilled in the art that the same techniques can be applied to audioconferencing systems or, indeed, web-only conferencing systems. Furthermore, the AHU may feature full video and audio communication capability.

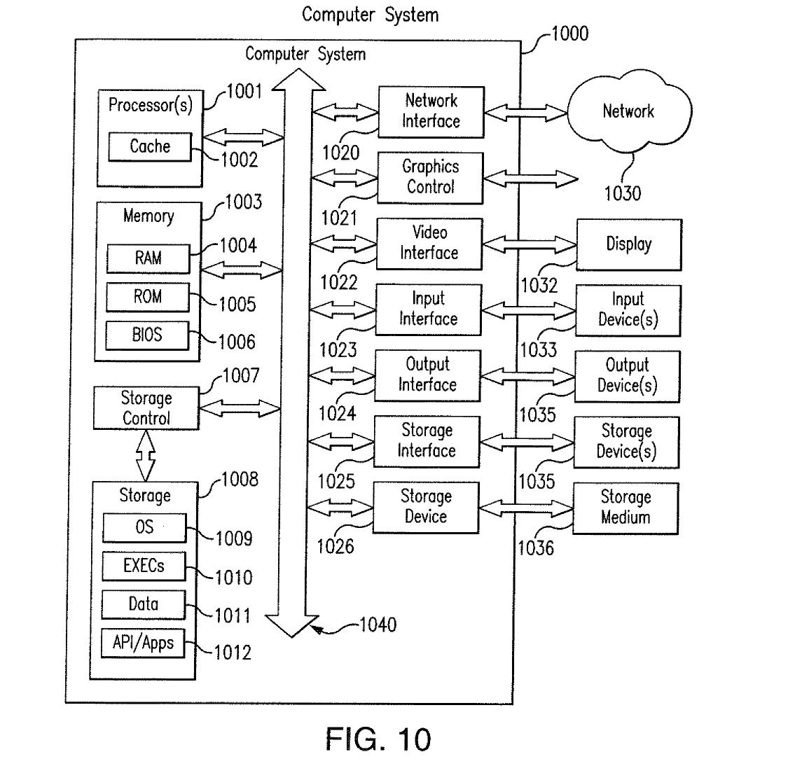

The methods for ad-hoc integration of tablets and phones in video communication systems described above can be implemented as computer software using computer-readable instructions and physically stored in computer-readable medium. The computer software can be encoded using any suitable computer languages. The software instructions can be executed on various types of computers. For example, FIG. 10 illustrates a computer system 1000 suitable for implementing embodiments of the present disclosure.

The components shown in FIG. 10 for computer system 1000 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 1000 can have many physical forms including an integrated circuit, a printed circuit board, a small handheld device (such as a mobile telephone or PDA), a personal computer or a super computer.

Computer system 1000 includes a display 1032, one or more input devices 1033 (e.g., keypad, keyboard, mouse, stylus, etc.), one or more output devices 1034 (e.g., speaker), one or more storage devices 1035, various types of storage medium 1036.

The system bus 1040 link a wide variety of subsystems. As understood by those skilled in the art, a “bus” refers to a plurality of digital signal lines serving a common function. The system bus 1040 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 1001 (also referred to as central processing units, or CPUs) optionally contain a cache memory unit 1002 for temporary local storage of instructions, data, or computer addresses. Processor(s) 1001 are coupled to storage devices including memory 1003. Memory 1003 includes random access memory (RAM) 1004 and read-only memory (ROM) 1005. As is well known in the art, ROM 1005 acts to transfer data and instructions uni-directionally to the processor(s) 1001, and RAM 1004 is used typically to transfer data and instructions in a bi-directional manner. Both of these types of memories can include any suitable of the computer-readable media described below.

A fixed storage 1008 is also coupled bi-directionally to the processor(s) 1001, optionally via a storage control unit 1007. It provides additional data storage capacity and can also include any of the computer-readable media described below. Storage 1008 can be used to store operating system 1009, EXECs 1010, application programs 1012, data 1011 and the like and is typically a secondary storage medium (such as a hard disk) that is slower than primary storage. It should be appreciated that the information retained within storage 1008, can, in appropriate cases, be incorporated in standard fashion as virtual memory in memory 1003.

Processor(s) 1001 is also coupled to a variety of interfaces such as graphics control 1021, video interface 1022, input interface 1023, output interface 1024, storage interface 1025, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 1001 can be coupled to another computer or telecommunications network 1030 using network interface 1020. With such a network interface 1020, it is contemplated that the CPU 1001 might receive information from the network 1030, or might output information to the network in the course of performing the above-described method. Furthermore, method embodiments of the present disclosure can execute solely upon CPU 1001 or can execute over a network 1030 such as the Internet in conjunction with a remote CPU 1001 that shares a portion of the processing.

According to various embodiments, when in a network environment, i.e., when computer system 1000 is connected to network 1030, computer system 1000 can communicate with other devices that are also connected to network 1030. Communications can be sent to and from computer system 1000 via network interface 1020. For example, incoming communications, such as a request or a response from another device, in the form of one or more packets, can be received from network 1030 at network interface 1020 and stored in selected sections in memory 1003 for processing. Outgoing communications, such as a request or a response to another device, again in the form of one or more packets, can also be stored in selected sections in memory 1003 and sent out to network 1030 at network interface 1020. Processor(s) 1001 can access these communication packets stored in memory 1003 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 1000 can provide functionality as a result of processor(s) 1001 executing software embodied in one or more tangible, computer-readable media, such as memory 1003. The software implementing various embodiments of the present disclosure can be stored in memory 1003 and executed by processor(s) 1001. A computer-readable medium can include one or more memory devices, according to particular needs. Memory 1003 can read the software from one or more other computer-readable media, such as mass storage device(s) 1035 or from one or more other sources via communication interface. The software can cause processor(s) 1001 to execute particular processes or particular parts of particular processes described herein, including defining data structures stored in memory 1003 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosed subject matter. It will thus be appreciated that those skilled in the art will be able to devise numerous systems and methods which, although not explicitly shown or described herein, embody the principles of the disclosed subject matter and are thus within its spirit and scope.

What is claimed is:

1. A communication system comprising:
a first communication device equipped with a display, coupled to a communication network,
a second communication device equipped with a camera, coupled to the communication network,
wherein the first communication device is capable of displaying a visual encoding of information that allows the second communication device to join a communication session in which the first communication device is participating, and
wherein the second communication device is capable of scanning the visual encoding of information that the first communication device is displaying and joining the communication session in which the first communication device is participating.

2. The system of claim 1, wherein the visual encoding of information comprises one or more QR codes.

3. A communication system comprising:
a first communication device equipped with a camera, coupled to a communication network,
a second communication device equipped with a display, coupled to the communication network,
wherein the second communication device is capable of displaying a visual encoding of information that allows the first communication device to add it to a communication session in which the first communication device is participating, and
wherein the first communication device is capable of scanning the visual encoding of information that the second communication device is displaying and adding the second communication device to the communication session that it is participating.

4. The system of claim 3, wherein the visual encoding of information comprises one or more QR codes.

5. A method for adding a first communication device into a communication session in which a second communication device is participating, the method comprising:
displaying on the second communication device a visual encoding of information that will enable the first communication device to join the communication session,
scanning on the first communication device the visual encoding of information displayed by the first communication device, and
using the scanned said visual encoding of information to join the communication session.

6. The method of claim 5, wherein the visual encoding of information comprises one or more QR codes.

7. A method for adding a first communication device into a communication session in which a second communication device is participating, the method comprising:
displaying on the first communication device a visual encoding of information that will enable the second communication device to join the communication session,
scanning on the second communication device the visual encoding of information displayed by the first communication device,
using the scanned said visual encoding of information to invite the first communication device to the communication session, and
accepting the invitation and joining the communication session.

8. The method of claim 7, wherein the visual encoding of information comprises one or more QR codes.

9. A method for adding a first communication device into a communication session in which a second communication device is participating, the method comprising the steps of:
sending by the second communication device a URL encoding of information that will enable the first communication device to join the communication session,
accessing by the first communication device the URL encoding of information sent by the second communication device, and
using the said URL encoding of information to join the communication session.

10. A non-transitory computer-readable medium comprising a set of executable instructions to direct a processor to perform the method in claim 5.

11. A non-transitory computer-readable medium comprising a set of executable instructions to direct a processor to perform the method claim 6.

12. A non-transitory computer-readable medium comprising a set of executable instructions to direct a processor to perform the method in claim 7.

13. A non-transitory computer-readable medium comprising a set of executable instructions to direct a processor to perform the method in claim 8.

14. A non-transitory computer-readable medium comprising a set of executable instructions to direct a processor to perform the method in claim 9.
